(19) United States
(12) Patent Application Publication
(10) Pub. No.: US 2009/0112711 A1
(43) Pub. Date: Apr. 30, 2009

(54) TRANSACTION PRODUCT WITH MOVABLE MEMBER

(75) Inventors: Timothy P. CLEGG, Manhatten Beach, CA (US); Primoz SAMARDZIJA, Marina del Ray, CA (US); Timothy SCHUMANN, Arden Hills, MN (US); Natalie SCHAEFER, Minneapolis, MN (US); Erin M. BORKOWSKI, Andover, MN (US)

Correspondence Address: TARGET BRANDS, INC., 1000 NICOLLET MALL, TPS-3165, MINNEAPOLIS, MN, 55403, US

(73) Assignee: TARGET BRANDS, INC., MINNEAPOLIS, MN (US)

(21) Appl. No.: 11/932,044

(22) Filed: Oct. 31, 2007

(51) Int. Cl. G06Q 30/00; G06K 19/00

(52) U.S. Cl. 705/14; 235/486; 235/487; 439/131

(57) ABSTRACT

A transaction product includes a first member, a second member and an account identifier. The first member defines a window. The second member is substantially enclosed within the first member and depicts a first image and a second image. The second member is selectively movable relative to the first member between a first position, in which the first image is viewable through the window, and a second position, in which the second image is viewable through the window. The account identifier links the transaction product to an account or record and is machine readable. The account identifier is at least one of connected to and substantially enclosed within the first member. Other cards, products, assemblies and methods of using such cards, products and assemblies are also disclosed.

### BACKGROUND OF THE INVENTION

Stored-value cards and other transaction cards come in many forms. A gift card, for example, is a type of stored-value card that includes a pre-loaded or selectively loaded monetary value. In one example, a consumer buys a gift card having a specified value for presentation as a gift to another person. In another example, a consumer is offered a gift card as an incentive to make a purchase. A gift card, like other stored-value cards, can be “recharged” or “reloaded” at the direction of the bearer. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. Gift cards and other transaction cards provide a number of advantages to both the consumer and the retailer.

### SUMMARY OF THE INVENTION

One aspect of the present invention relates to a transaction product including a first member, a second member and an account identifier. The first member defines a window. The second member is substantially enclosed within the first member and depicts a first image and a second image. The second member is selectively movable relative to the first member between a first position, in which the first image is viewable through the window, and a second position, in which the second image is viewable through the window. The account identifier links the transaction product to an account or record and is machine readable. The account identifier is at least one of connected to and substantially enclosed within the first member. Other related products and methods are also disclosed and provide additional advantages.

### BRIEF DESCRIPTION OF THE DRAWINGS

Embodiments of the invention will be described with respect to the figures, in which like reference numerals denote like elements, and in which:

FIG. 1 is a perspective view illustration of a transaction product in a first position, according to one embodiment of the present invention.

FIG. 2 is a front view illustration of the transaction product of FIG. 1, according to one embodiment of the present invention.

FIG. 3 is a rear view illustration of the transaction product of FIG. 1, according to one embodiment of the present invention.

FIG. 4 is a top view illustration of the transaction product of FIG. 1, according to one embodiment of the present invention, wherein the bottom view is a mirror image thereof.

FIG. 5 is a right side view illustration of the transaction product of FIG. 1, according to one embodiment of the present invention.

FIG. 6 is a left side view illustration of the transaction product of FIG. 1, according to one embodiment of the present invention.

FIG. 7 is a front view illustration of the transaction product of FIG. 1 in an intermediate position, according to one embodiment of the present invention.

FIG. 8 is a front view illustration of the transaction product of FIG. 1 in an extended position, according to one embodiment of the present invention.

FIG. 9 is an inside rear view illustration of an unfolded external member of the transaction product of FIG. 1, according to one embodiment of the present invention.

FIG. 10 is a front view illustration of an unfolded actuating member of the transaction product of FIG. 1, according to one embodiment of the present invention.

FIG. 11 is a front view illustration of the actuating member in a folded position, a movable member and a support member of the transaction product of FIG. 1, according to one embodiment of the present invention.

FIG. 12 is a front view illustration of a slotted member of the transaction product of FIG. 1, according to one embodiment of the present invention.

FIG. 13 is a front view illustration of the actuating member in the folded position, the movable member and the support member of FIG. 11 with the slotted member of FIG. 12, according to one embodiment of the present invention.

FIG. 14 is a top view of a partially assembled transaction product in a first position, according to one embodiment of the present invention.

FIG. 15 is a cross-sectional view illustration of the transaction product of FIG. 8 taken about the line 15-15, according to one embodiment of the present invention.

FIG. 16 is a front view illustration of an unfolded backer, according to one embodiment the present invention.

FIG. 17 is a rear view illustration of a transaction product assembly including the backer of FIG. 16 with the transaction product of FIG. 1, according to one embodiment of the present invention.

FIG. 18 is a flow chart illustrating a method of assembling a transaction product assembly, according to one embodiment of the present invention.

FIG. 19 is a flow chart illustrating a method of encouraging purchase and facilitating use of a transaction product, according to one embodiment of the present invention.

FIG. 20 is a flow chart illustrating a method of using a transaction product, according to one embodiment of the present invention.

### DETAILED DESCRIPTION

The following detailed description merely provides examples of the invention and is not intended to limit the invention or the application and uses of the invention. Furthermore, there is no intention to be bound by any theory presented in the preceding background of the invention or the following detailed description of the invention.

A gift card or other transaction product is adapted for making purchases of goods and/or services from e.g., a retail store or website. According to one embodiment, an original consumer buys the transaction product to give a recipient who in turn is able to use the transaction product at a retail store or setting to pay for goods and/or services. The transaction product, according to embodiments of the present invention, provides the consumer and recipient with extra functionality in addition to the ability to pay for goods and/or services with the transaction product. In particular, the transaction product presents the original consumer and/or other bearer of the transaction product with a variable visual presentation in the form of a movable member.

More specifically, in one example, the transaction product including a movable member movably housed substantially within an external or enclosure member. The enclosure member includes an opening or window for viewing portions of the movable member aligned therewith. Upon bearer interaction with the transaction product, the portion of the movable member that is aligned with the window changes, which thereby changes what a bearer of the transaction product views through the window. In one embodiment, the movable member includes a first portion viewed through the window when in a first or initial position and a second portion viewed through the window when in a second or final position. The first portion and the second portion are visually differentiated from one another. For example, the first portion may depict a gift wrapped present and the second portion may depict a festive message such as “Merry Christmas.” As such, upon moving the movable member between the first position and the second position changes the item viewed through the window, for example, from the gift wrapped present to the festive message. In one embodiment, the changeable or movable nature of the transaction product provides amusement to the user and thereby promotes purchase of the transaction product.

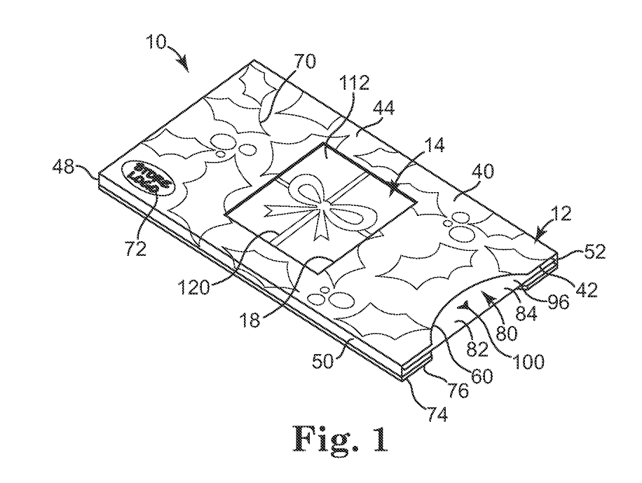

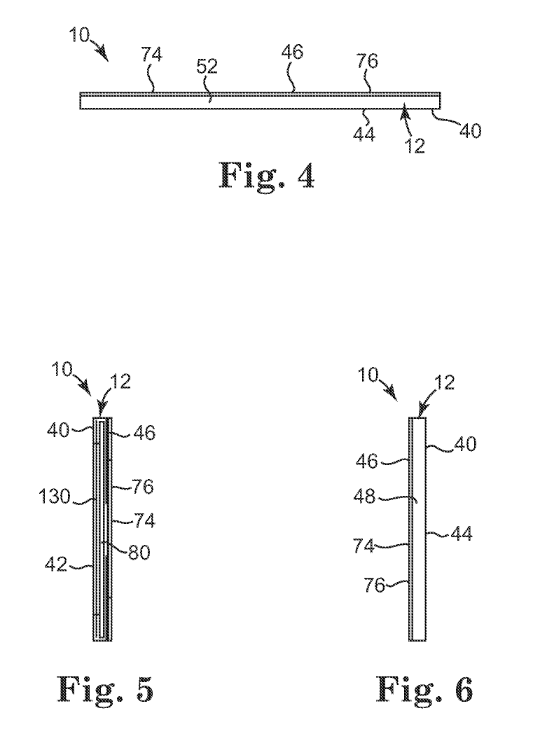

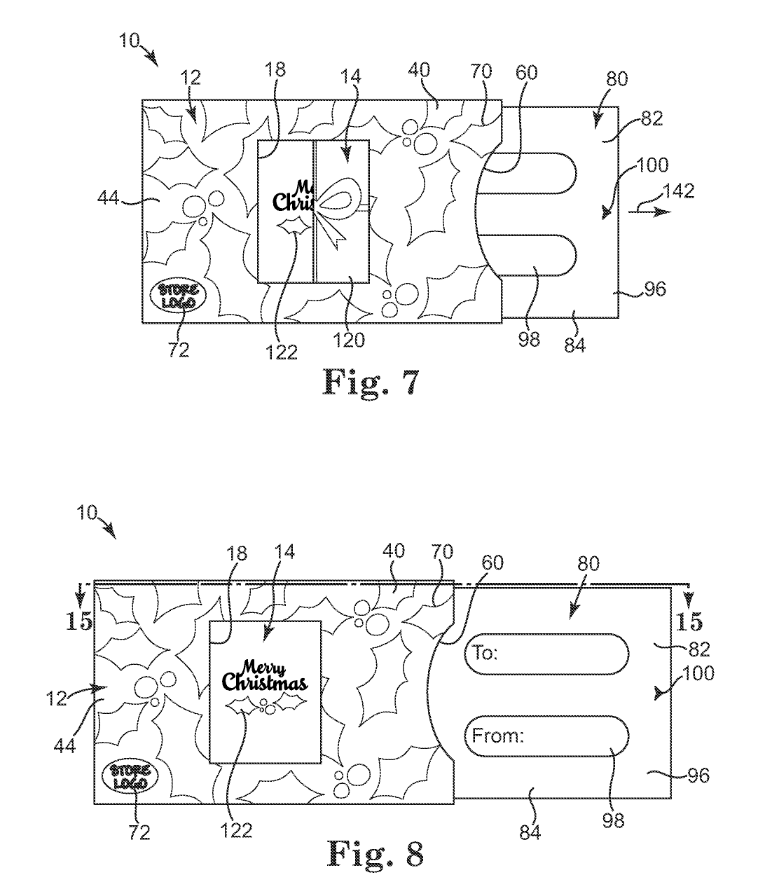

Turning to the figures, FIGS. 1-6 illustrate one embodiment of a transaction product 10 such as a stored-value product (e.g., gift card, phone card, etc.), credit product, etc. in an initial or first position, according to the present invention. Transaction product 10 is configured to be used toward the purchase and/or use of goods and/or services and includes an external or enclosure member 12 (e.g., a first member), a movable member 14 (e.g., a second member) and an account identifier 16 (FIG. 3). Enclosure member 12 substantially encloses movable member 14 and defines a window 18. Movable member 14 is positioned and movable within enclosure member 12 to selectively alter a portion thereof viewable through window 18. As such, the bearer of transaction product 10 interacts with transaction product 10 causing movement of movable member 14 within enclosure member 12 to reveal an otherwise hidden portion of movable member 14. More specifically, the bearer interacts with transaction product 10 to transition movable member 14 from the first position illustrated in FIG. 1, through the intermediate position illustrated in FIG. 7 and to the second position illustrated in FIG. 8.

Referring to the rear view of FIG. 3, in one embodiment, account identifier 16 is at least one of connected to and enclosed within enclosure member 12 such that account identifier 16 is easily accessed to identify an account or record to which transaction product 10 is linked. In one example, account identifier 16 includes one or more of a bar code, magnetic strip, a smart chip or other electronic device, a radio frequency identification (RFID) device or other suitable identifier readily machine readable by a point-of-sale terminal or other account access station or kiosk. The account or record of the monetary or other balance on transaction product 10 optionally is maintained on a database, other electronic or manual record-keeping system or, in the case of “smart” cards for example, on a chip or other electronic device(s) on transaction product 10 itself. Accordingly, by scanning account identifier 16, the account or record linked to transaction product 10 is identified and can subsequently be activated, have amounts debited therefrom and/or have amounts added thereto.

In one embodiment, account identifier 16 includes a character string or code 30 (e.g., a number and/or letter string) configured to provide additional security to the user of transaction product 10 and/or configured to be read by a bearer of transaction product 10 to facilitate use of transaction product 10 for web site or other purchases outside of brick-and-mortar type retail establishments. With the above in mind, account identifier 16 is one example of means for linking transaction product 10 with an account or record, and scanning of account identifier 16 is one example of means for activating or loading value on transaction product 10.

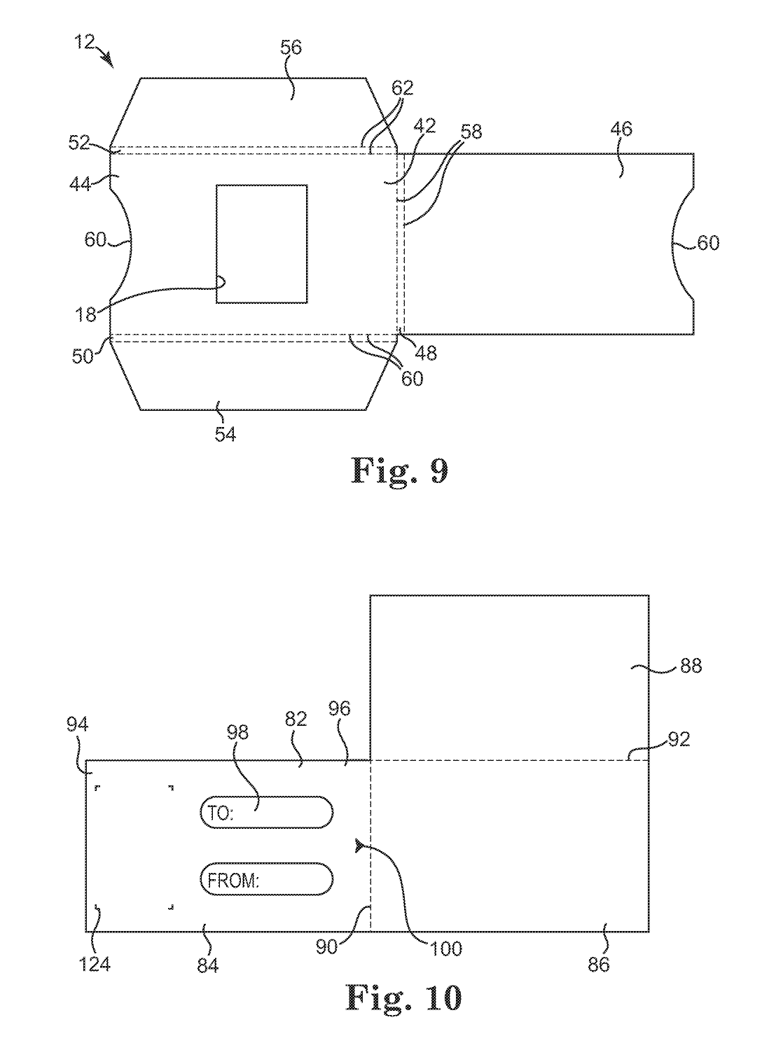

FIG. 9 illustrates one embodiment of an inside view of enclosure member 12 in an unfolded position. In one embodiment, enclosure member 12 is formed of any readily foldable material such as a paper based (e.g., paper, cardstock, and cardboard) or fully or partially plastic based material. In one example, enclosure member 12 is formed of a 150# text stock weight paperboard. When unfolded, enclosure member 12 is substantially planar and defines an external surface 40 (FIGS. 1-6) and an internal surface 42 (FIG. 9) opposite external surface 40. Enclosure member 12 defines a plurality of panels and walls each separated by one or more fold lines. More specifically, in one embodiment, enclosure member 12 defines a front panel 44, a rear panel 46, side walls 48, 50 and 52 and coupling flanges or flaps 54 and 56. Front panel 44 and rear panel 46 are sized and shaped substantially similar to one another. In one example, front panel 44 and rear panel 46 are each substantially rectangular and have an overall size similar to an identification card, a credit card or other card sized to fit in a wallet of a user. In other embodiments, either or both of front panel 44 and rear panel 46 are otherwise shaped as a square, circle, oval, star, etc.

Front panel 44, or alternatively, in one example, rear panel 46, defines window 18. Window 18 can take any suitable form allowing another component (e.g., movable member 14) of transaction product 10 to be viewed therethrough. For example, window 18 may be an opening, an opening with a transparent or translucent member extending thereacross or a transparent or translucent portion otherwise defined by enclosure member 12. In one embodiment, window 18 is laterally and longitudinally centered on front panel 44 and is formed of any suitable shape (e.g., as a square, rectangle, circle, oval or triangle).

In one example, front panel 44 and rear panel 46 are separated by a first or end side wall 48. Fold lines 58 are each defined along an opposite edge of first side wall 48, more specifically, at one of an intersection between first side wall 48 and front panel 44 and an intersection between first side wall 48 and rear panel 46. As such, front panel 44 and rear panel 46 of enclosure member 12 are configured to be folded toward one another about fold lines 58 such that portions of internal surface 42 defined by front panel 44 face portions of internal surface 42 defined by rear panel 46.

In one example, upon folding, front panel 44 and rear panel 46 are substantially aligned, are substantially parallel to one another and are spaced from one another by a distance substantially equal to a width of first side wall 48. As such, an end opening is defined by enclosure member 12 opposite first side wall 48. In one embodiment, each of front panel 44 and rear panel 46 define a cutout 60, for example, a semicircular cut out, formed on opposite edges of front panel 44 and rear panel 46 (i.e., edges of each of front panel 44 and rear panel 46 opposite first side wall 48). In one example, the boundaries of each cutout 60 at least partially defines the end opening of enclosure member 12 positioned opposite first side wall 48. Although primarily described about as being formed of a foldable paper or plastic material, in on embodiment, enclosure member 12 may be formed of as an injection molded casing or other relatively rigid casing as will be apparent to one of skill in the art upon reading the present application.

In one embodiment, side walls 50 and 52 each border and extend from opposing edges of front panel 44, and one of coupling flaps 54 and 56 extends from each of side walls 50 and 52 opposite front panel 44. Where front panel 44 is substantially rectangular, side walls 50 and 52 longitudinally extend substantially parallel to one another and substantially perpendicular to side wall 48. Fold lines 62 and 64 respectively border edges of side walls 50 and 52 adjacent front panel 44 of flaps 54 and 56. Flaps 54 and 56 are configured to be folded about fold lines 62 and 64 toward the portion of internal surface 42 defined by front panel 44. In one embodiment, upon folding rear panel 46, side walls 48, 50 and 52 and flaps 54 and 56 relative to front panel 44, side walls 48, 50 and 52 extending substantially perpendicular to front panel 44, rear panel 46 and flaps 54 and 56, which extend substantially parallel to one another.

In one embodiment, external surface 40 of enclosure member 12 includes any suitable indicia. For example, external surface 40 includes one or more of decorative indicia 70 and brand indicia 72. In one embodiment, decorative indicia 70 relate to a particular occasion, such as a wedding, new baby, graduation, holiday, season, brand identifier, media format identifier or other visual design to promote purchase of transaction product 10. Brand indicia 72 identify a brand associated with transaction product 10 such as identifying a product brand, a store brand, a department, etc. Other indicia may also be included on enclosure member 12 as will be apparent to those of skill in the art.

Referring to FIGS. 1-6, in one example, transaction product 10 includes a support substrate 74 configured to provided additional rigidity and strength to transaction product 10. In one embodiment, support substrate 74 is substantially planar and is formed of any suitable material such as paper, plastic (e.g., polycarbonate, polystyrene, polyvinyl chloride (PVC), acrylonitrile butadiene styrene (ABS), polyethylene terephthalate (PET), teslin, polyactide (PLA) and acrylic) or other suitable material. In one example, support substrate 74 is sized similarly to rear panel 46 and is adhered or otherwise rigidly coupled with a portion of external surface 40 defined by rear panel 46 of enclosure member 12. In one embodiment, account identifier 16 is printed to or otherwise applied to an external surface 76 of support substrate (e.g., a surface of support substrate 74 opposite rear panel 46 of enclosure member 12) as illustrated in FIG. 3. In example, one or more of decorative indicia 70, brand indicia 72 and/or other indicia are included on support substrate 74 in addition or as an alternative to inclusion of decorative indicia 70, brand indicia 72 and/or other indicia on enclosure member 12.

In one embodiment, redemption indicia 78 are included on external surface 76 of support substrate 74. Redemption indicia 78 indicate that transaction product 10 is redeemable for the purchase or use of goods and/or services and that, upon use, a value of the purchased goods and/or services will be deducted from the financial account or record linked to transaction product 10. In one embodiment, redemption indicia 78 include phrases such as “<NAME OF STORE> GiftCard” and “This GiftCard is redeemable for merchandise or services at any of our stores or at our web site,” and/or provides help (e.g., account balance or other information) or phone line information in case of a lost, stolen or damaged stored-value card, etc. In one embodiment, for example, where no support substrate 74 is included as part of transaction product 10, redemption indicia 78 are alternatively printed or otherwise applied to external surface 40 of enclosure member 12.

In one embodiment, transaction product 10 includes an actuating member 80 (e.g., a third member) configured to facilitate movement of movable member 14 relative to enclosure member 12. FIG. 10 illustrates one embodiment of actuating member 80 in an unfolded position. In one embodiment, actuating member 80 is formed of any readily foldable material such as a paper based (e.g., paper, cardstock and cardboard) or fully or partially plastic based material. When unfolded, actuating member 80 is substantially planar and defines an external surface 82 and an internal surface (not shown) positioned opposite external surface 82.

Actuating member 80 is divided into a front panel 84, a rear panel 86 and, in one example, a strengthening panel 88 by fold lines 90 and 92. In one embodiment, actuating member 80 defines front panel 84 longitudinally adjacent rear panel 86 divided only by fold line 90. More specifically, front panel 84 defines a first end 96 longitudinally opposite a second end 94, wherein fold line 90 is adjacent first end 96 of front panel 84. In one example, front panel 84 and rear panel 86 are sized and shaped similarly to one another. Upon assembly, portions of the internal surface (not shown) defined by front panel 84 and portions of the internal surface defined by rear panel 86 are folded toward each other about fold line 90. As such, a portion of external surface 82 defined by front panel 84 is positioned substantially parallel to and opposite a portion of external surface 82 defined by rear panel 86.

In order to provide additional strength and rigidity to actuating member 80, in one example, strengthening panel 88 abuts an edge of one of front panel 84 and rear panel 86 with fold line 92 being formed along an intersecting line therebetween. In one embodiment, strengthening panel 88 is folded about fold line 92 toward a portion of the internal surface defined by the corresponding front panel 84 or rear panel 86 prior to folding actuating member 80 about fold line 90. As such, upon final folding, strengthening panel 88 adds rigidity and strength to actuating member 80 while being substantially hidden from view. In one example, wherein actuating member 80 is formed of a stronger more rigid material or configuration (e.g., a relatively thick planar piece of plastic) one or both of rear panel 86 and strengthening panel 88 may be eliminated.

In one embodiment, front panel 84 includes one or more message fields 98 depicted thereon. Message fields 98, for example, are configured to be written to by the bearer of transaction product 10 prior to presenting transaction product 10 to a recipient. In one embodiment, message fields 98 include one or more of “to,” “from” and “amount” fields. Message fields 98 facilitate the consumer in preparing transaction product 10 for gifting to a recipient. In one embodiment, message fields 98 are positioned nearer first end 96 of front panel 84 as compared to second end 94 of front panel 84.

In one example, front panel 84 depicts an arrow 100 or other feature configured to instruct a bearer of transaction product 10 how to transition movable member 14 between a first position (FIG. 1) and a second position (FIG. 8) as will be further described below. In one embodiment, arrow 100 is positioned near first end 96 of front panel 84. Other indicia may be included on either of front panel 84 and rear panel 86 as will be apparent to those of skill in the art upon reading the present application.

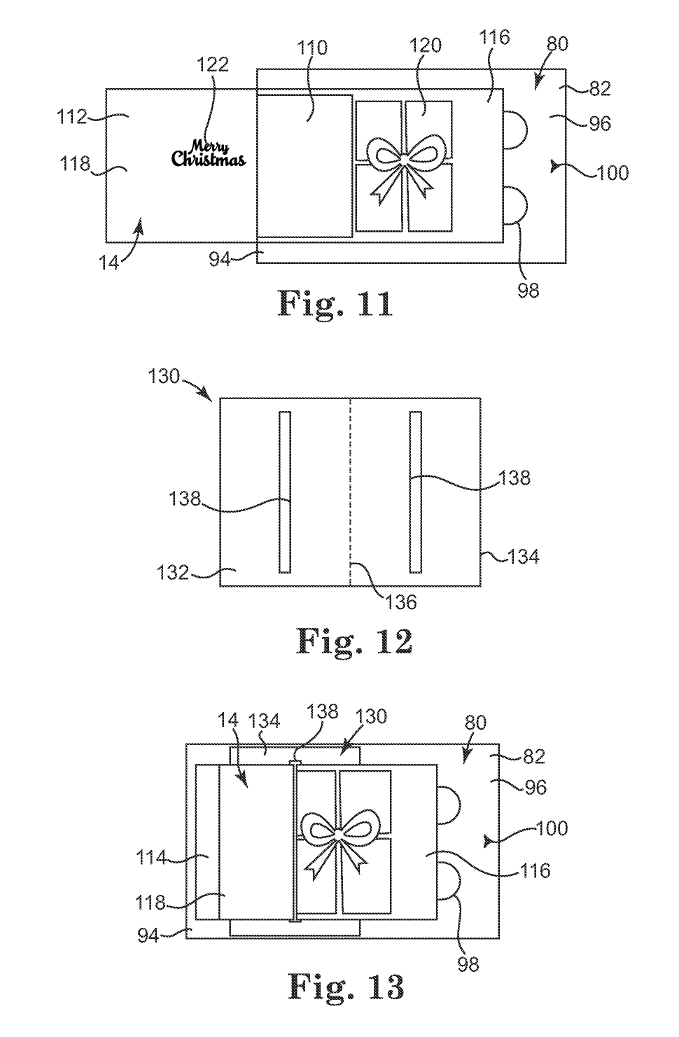

FIG. 11 illustrates actuating member 80 in a folded configuration coupled with movable member 14 and a support member 110. In one embodiment, movable member 14 is substantially planar and defines a front surface 112 and a rear surface 114 (FIGS. 13-15) opposite front surface 112. Movable member 14 is substantially elongated and defines a first end 116 and a second end 118. In one example, movable member 14, more specifically, front surface 112 of movable member 14 depicts a first image 120 and a second image 122. First image 120 is positioned nearer to first end 116 than second image 122, and therefore, second image 122 is positioned nearer to second end 118 than first image 120. In one embodiment, first image 120 is separately defined and spaced from second image 122. In view of the above, movable member 14 is one example of means for depicting a first image and/or a second image.

In one example, each of first image 120 and second image 122 includes one or more of a pictorial graphic (e.g., a graphic image of a gift wrapped present) and a text image or message (e.g., a festive or other text based message such as “Merry Christmas”). Movable member 14 is formed of a readily flexible material, for example, a paper based material. In one example, movable member 14 is formed of an 80# text stock weight paper configured to withstand repeated folding and manipulation without substantial creasing.

Rear surface 114 of movable member 14 is coupled with a portion of external surface 82 defined by front panel 84. More specifically, a portion of movable member 14 between first image 120 and second image 122 is adhered to or otherwise suitably coupled (in one example, rigidly coupled) to front panel 84 of actuating member 80 near second end 94 of front panel 84, for example, at a position on actuating member 80 generally indicated by corner marks 124 in FIG. 10. Upon coupling movable member 14 with actuating member 80, when movable member 14 is laid in a substantially planar orientation over actuating member 80 as illustrated in FIG. 11, first end 116 and, in one example, first image 120 of movable member 14 do not extend beyond first end 96 of actuating member 80. In one example, following coupling, second end 118 and second image 122 extends beyond second end 94 of actuating member 80.

In one embodiment, support member 110 is coupled to front surface 112 of movable member 14 directly opposite the coupling of rear surface 114 of movable member 14 to actuating member 80. As such, a portion of movable member 14 between first image 120 and second image 122 is interposed between actuating member 80 and support member 110. Support member 110 is generally rectangular and is formed of a material with more strength and rigidity than movable member 14. As such, support member 110 is configured to prevent or at least decrease flexing of movable member 14 where movable member 14 is coupled with support member 110 and actuating member 80.

FIG. 12 illustrates one embodiment of a slotted member 130 in an unfolded position. In one example, slotted member 130 defines a first panel 132 and a second panel 134, which is sized and shaped similarly to and positioned adjacent first panel 132. A fold line 136 is defined between first panel 132 and second panel 134. In one embodiment, each of first panel 132 and second panel 134 define an elongated aperture or slot 138 extending substantially parallel to fold line 136. When folded about fold line 136, slot 138 of first panel 132 aligns with slot 138 of second panel 134. Each slot 138 has a length similar to but slightly larger than a lateral width of movable member 14. Forming slotted member 130 of two panels folded together serves to strength to slotted member 130. However, where slotted member 130 is formed of a material having sufficient strength, slotted member 130 may define first panel 132 with the corresponding slot 138, and second panel 134 and fold line 136 may be eliminated.

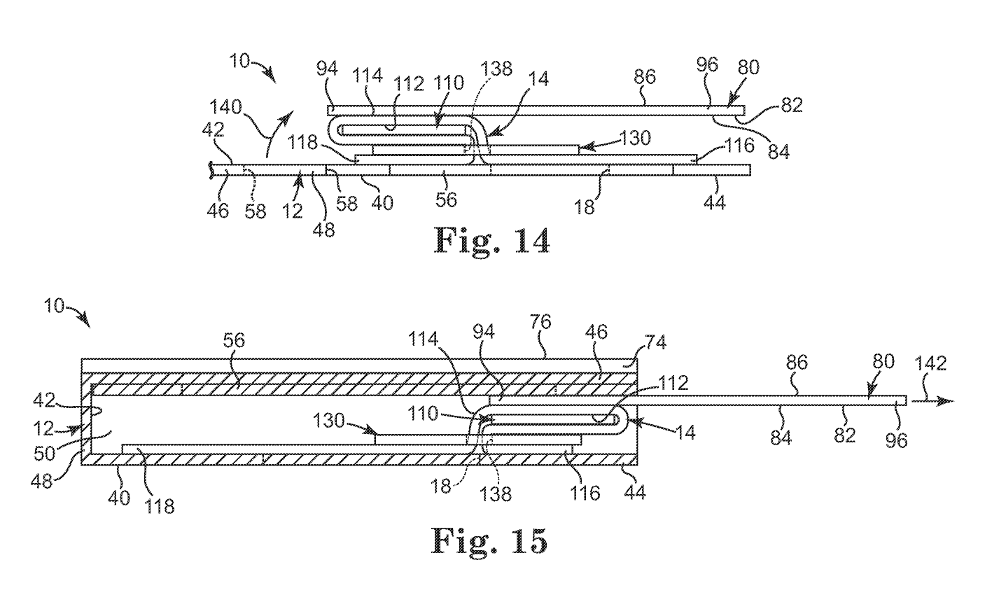

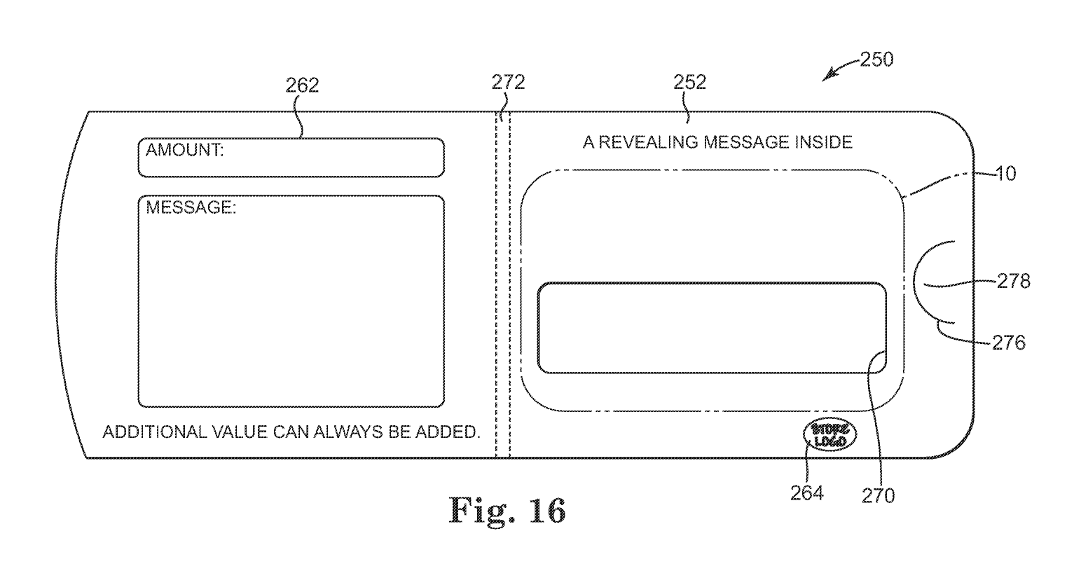

During assembly of transaction product 10, movable member 14 is coupled to actuating member 80 and, in one example, support member 110 is coupled to movable member 14 in the manner described above with respect to and as illustrated in FIG. 11. Subsequently, movable member 14 is flexed or folded but generally not creased to move first end 116 and second end 118 of movable member 14 toward one another and through elongated aperture(s) 138 of slotted member 130 as illustrated with additional reference to the front view of FIG. 13 and the top view of FIG. 14. Notably, the thicknesses of the various components of transaction product 10 are exaggerated in FIGS. 14 and 15 for illustrative purposes.

Each of first end 116 and second end 118 of movable member 14 are pulled away from slot 138 in separate directions. For example, in one embodiment, first end 116 is pulled toward first end 96 of actuating member 80 and second end 118 is pulled toward second end 94 of actuating member 80. As such, while mid-portions of movable member 14 are coupled to actuating member 80 and are folded about support member 110 on a rear side of slotted member 130, first end 116, second end 118 and portions adjacent first end 116 or second end 118 are positioned on an opposite front side of slotted member 130. In one example, first end 116, second end 118 and portions adjacent first end 116 or second end 118 (i.e., portions of movable member 14 positioned on a front side of dividing member 1340) are pulled in opposite directions away from slot 138 of slotted member 130 such that first end 116, second end 118 and portions adjacent first end 116 or second end 118 extend substantially parallel to slotted member 130 and actuating member 80.

Actuating member 80, which is now attached to movable member 14, support member 110 and slotted member 130, is placed relative to enclosure member 12. More specifically, referring to FIGS. 9 and 13 in view of FIG. 14, actuating member 80 is generally positioned such that a portion of external surface 82 defined by front panel 84 thereof faces a portion of internal surface 42 formed by front panel 44 of enclosure member 12. As such, movable member 14 is positioned between front panel 84 of actuating member 80 and front panel 44 of enclosure member 12. Upon positioning, first end 116 and second end 118 of movable member 14 are adhered or otherwise suitably coupled (for example, rigidly coupled) to internal surface 42 of front panel 44 on opposite sides (e.g., a first side and as second side) of window 18 defined by front panel 44.

Following coupling of movable member 14 to front panel 44 of enclosure member 12, flaps 54 and 56 of enclosure member 12 are each folded about fold lines 62 and 64 away from portions of external surface 40 of front panel 44 and toward the other of flaps 54 and 56. Rear panel 46 and side wall 48 are folded about fold lines 58 as generally indicated by arrow 140 of FIG. 14 to wrap around actuating member 80, movable member 14 and slotted member 130 and to interface with, more specifically, to be adhered or otherwise coupled to, portions of external surface 40 defined by each of flaps 54 and 56 as generally indicated with additional reference to the cross sectional view of FIG. 15. As such, actuating member 80, movable member 14 and slotted member 130 are initially substantially enclosed within folded enclosure member 12. In view of the above, enclosure member 12 is one example of means for substantially enclosing movable member 14 and/or actuating member 80.

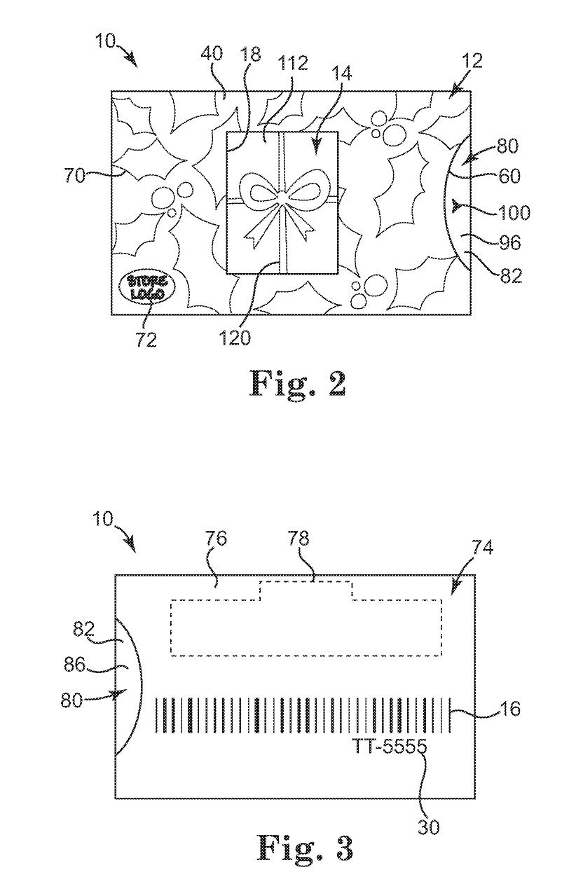

In one embodiment, once substantially enclosed within enclosure member 12, movable member 14, more specifically, first image 120 of movable member 14 is at least partially visible through window 18 as illustrated in FIGS. 1 and 2. In one embodiment, prior to or following folding of enclosure member 12, support substrate 74 is coupled to rear panel to provide additional strength and rigidity to transaction product 10.

Upon assembly, transaction product 10 is configured for non-transactional use. In particular, transaction product 10 is configured to provide a changing message or image through window 18. Referring to FIG. 2, a bearer of transaction product 10 pulls or otherwise interacts with first end 96 of actuating member 80 to move actuating member 80 in a longitudinal direction as generally indicated by arrow 142 in FIG. 7 out of the end opening defined by enclosure member 12. Movement of actuating member 80 between a compact position shown in FIG. 2 and an extended position shown in FIG. 8 automatically causes movable member 14 to transition from a first position shown in FIG. 2, through intermediate positions such as that illustrated in FIG. 7 and finally to a second position shown in FIG. 8.

Movement of movable member 14 causes the portion of movable member 14 viewed through window 18 to gradually change from first image 120 at the first position to second image 122 at the second position. In one embodiment, a portion of each of first image 120 and second image 122 is shown at least in some of the intermediate positions of movable member 14 (e.g., the intermediate position illustrated in FIG. 7). As such, a hidden message in the form of second image 122 that is not viewable in the first position of movable member 14 can be revealed by actuating transaction product 10. In this manner, the bearer of transaction product 10 is amused. Movement of actuating member 80 in a direction opposite that indicated by arrow 142 in FIGS. 7 and 15 moves actuating member 80 from the extended position back to the compact position, and accordingly, also moves movable member 14 from the second position back to the first position. As such, movement of actuating member 80 and movable member 14 to change the portion of movable member 14 viewed through window 18 is readily repeatable. In view of the above, actuating member 80 is one example of means for actuating transaction product 10 to selectively hide and reveal first image 120 and second image 122.

In one embodiment, moving actuating member 80 also exposes at least a portion of external surface 82 defined by front panel 84 of actuating member 80, for example, the portion including the one or more message fields 98. As such, in one embodiment where the bearer is a recipient rather than the original consumer associated with transaction product 10, actuation of transaction product 10 also reveals to the bearer an identity of the individual who has presented or gifted transaction product 10 to the bearer. The revelation of the one or more message fields 98 also serves to amuse the bearer of transaction product 10.

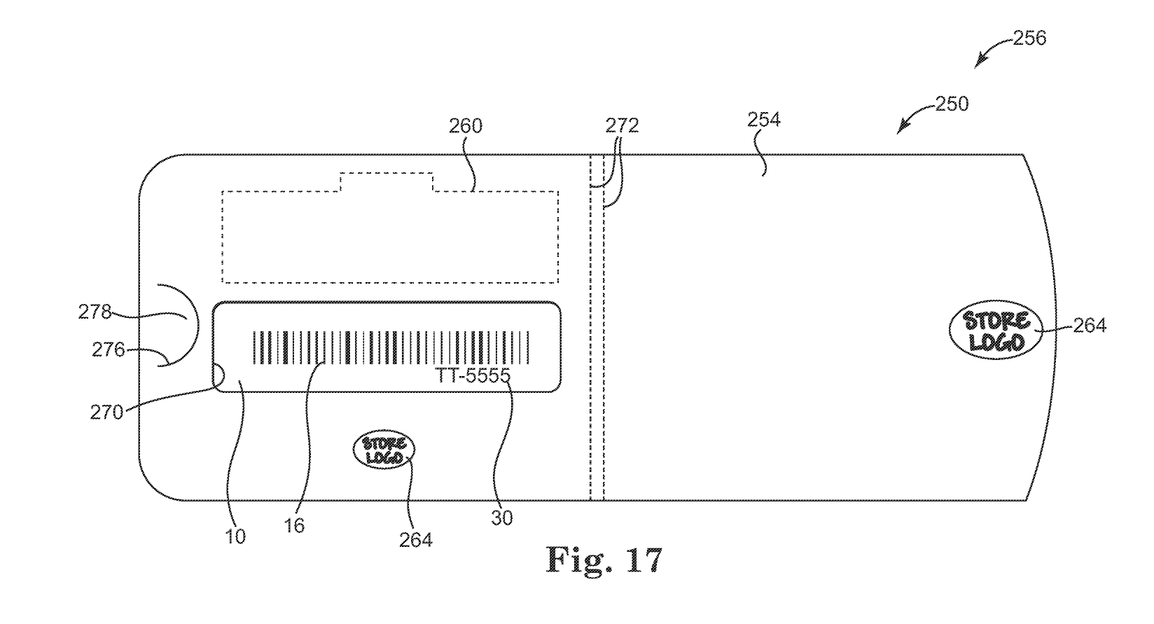

FIGS. 16 and 17 illustrate a carrier or backer 250 supporting transaction product 10 (FIGS. 1-6). Backer 250 comprises a single layer or multiple layers of paper or plastic material, for example, generally in the form of a relatively stiff but bendable/flexible card. Use of other materials is also contemplated. As such, backer 250 defines a first or front surface 252 (FIG. 16) and a second or rear surface 254 (FIG. 17). Transaction product 10, which is generally represented in phantom lines in FIG. 16 for illustrative purposes (e.g., to allow for full viewing of front surface 252), is readily releasably attached to backer 250, for example, by adhesive, blister packaging, overlying skinning material or the like, such that transaction product 10 with backer 250 collectively define a transaction product assembly 256 (FIG. 17).

Backer 250 displays indicia, graphics or text information including store logo(s), store name(s), slogans, advertising, instructions, directions, brand indicia, promotional information, holiday indicia, seasonal indicia, media format identifiers, characters and/or other information. The various indicia may be included on one or more of front surface 252 and rear surface 254. In one example, the indicia include one or more of redemption indicia 260, message field indicia 262, brand indicia 264, etc.

Redemption indicia 260, which are generally indicated with a dashed line box in FIG. 17, inform a bearer of transaction product assembly 256 that transaction product 10 is redeemable for the purchase or use of goods and/or services and that upon use, a value of the purchased goods and/or services will be deducted from the financial account or record linked to transaction product 10. In one embodiment, redemption indicia 260 include phrases such as “<NAME OF STORE> GiftCard” and “This GiftCard is redeemable for merchandise or services at any of our stores or at our website,” and/or provides help or phone line information in case of a lost, stolen or damaged transaction product 10, etc.

Message field indicia 262, for example, include one or more “to,” “from,” “amount” and “message” fields and are configured to be written to by the bearer of transaction product assembly 256 prior to presenting transaction product assembly 256 to a recipient. As such, message field indicia 262 facilitate the consumer in preparing transaction product assembly 256 for presentation to a recipient. In one embodiment, where the one or more message fields 98 (FIG. 8) of transaction product 10 includes one or more of the “to,” “from,” “amount” and “message” fields, message field indicia 262 includes the others of the “to,” “from,” “amount” and “message” fields.

Brand indicia 264 identify a store, brand, department, etc. and/or services associated with transaction product 10. Any other indicia such as decorative indicia may also be included on backer 250. Any of indicia 260, 262, 264, or other indicia optionally may appear anywhere on backer 250 or transaction product 10. Additional information besides that specifically described and illustrated herein may also be included.

In one embodiment, backer 250 includes a window or opening 270 for displaying account identifier 16 of transaction product 10 as illustrated in FIG. 17. As previously described, account identifier 16 is adapted for accessing an account or record associated with transaction product 10 for activating, loading or debiting value from the account or record. Accordingly, in one embodiment, opening 270 allows access to account identifier 16 to activate and/or load transaction product 10 without removing transaction product 10 from backer 250. In one embodiment, where opening 270 is eliminated, backer 250 is foldable or otherwise configured to provide access to account identifier 16 of transaction product 10 without removing transaction product 10 from backer 250.

In one embodiment, backer 250 is a bi-fold substrate defining one or more fold lines 272, about which backer 250 is foldable roughly in half. In FIGS. 16 and 17, backer 250 is unfolded, i.e. is in an open configuration. According to one embodiment, FIG. 16 illustrates front surfaces 252 of backer 250 that will be supported on a rack or other fixture to be visible to a consumer of a retail store who is considering the purchase of transaction product 10. In another example, while on display in a retail store, backer 250 is folded back about fold line(s) 272 to present only portions of front surfaces 252 of backer 250, i.e., surfaces illustrated in FIG. 16, that are positioned on the same side of fold line(s) 272 as transaction product 10 to a consumer. In such an embodiment, message field indicia 262 would not be visible to a consumer when backer 250 and transaction product 10 are placed for display in a retail store. In view of the above, backer 250 is one example of means for supporting transaction product 10 for display in a retail setting.

After purchase, backer 250 is foldable about fold line(s) 272 such that the FIG. 16 front surfaces 252 of backer 250 are folded toward each other and transaction product 10 is enclosed or wrapped in a compact package formed by foldable backer 250. In this manner, rear surfaces 254 of backer 250 (i.e., the surfaces illustrated in FIG. 17) are disposed toward the outside of the folded, compact package, according to embodiments of the invention. In one embodiment, folded backer 250 effectively wraps transaction product 10 for presentation from an original consumer to a recipient.

In one embodiment, a cut 276 is formed through backer 250 near an edge of backer 250 spaced from and substantially parallel to fold line(s) 272. Cut 276 extends partially toward fold line(s) 272 and defines a flap 278, which can be partially bent away from the remainder of backer 250. More specifically, upon folding of backer 250 about fold line(s) 272 to close backer 250 around transaction product 10, an opposing edge of backer 250 is tucked beneath flap 278 to maintain backer 250 in a folded or closed position. In one embodiment, cut 276 and flap 278 are each substantially semi-circular in shape. Other backers having various sizes and shapes, such as other foldable and non-foldable backers (not shown), can be used with various sizes and shapes of transaction products 10.

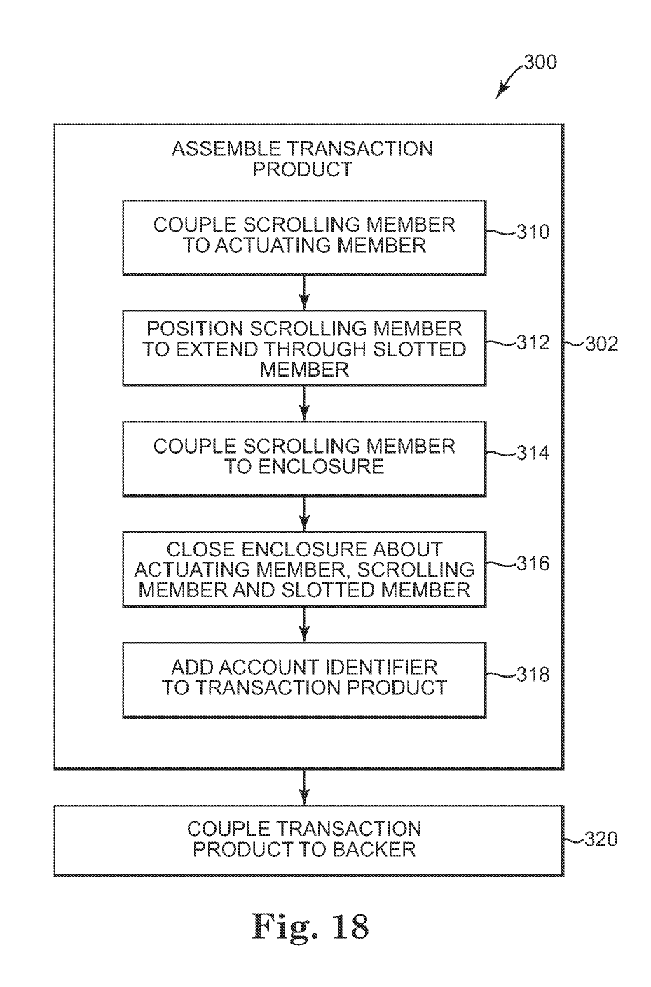

FIG. 18 is a flow chart illustrating one embodiment of a method 300 of assembling transaction product 10. Additionally referring to FIG. 11, in one example, at 310, rear surface 114 of movable member 14 is coupled with actuating member 80, for example, relatively near second end 94 of actuating member 80. In one embodiment, support member 110 is coupled to front surface 112 of movable member 14 directly opposite actuating member 80 as described above. At 312, first end 116 and second end 118 are moved toward each other and through slot 138 to a front side of slotted member 130 as illustrated in FIG. 13.

Once on the front side of slotted member 130, first end 116 and second end 118 are moved away from one another to exposed portions of front surface 112 defined by first end 116 and second end 118 of movable member 14. At 314, front surface 112 of first end 116 and second end 118 are adhered to or otherwise coupled to enclosure member 12 on opposite sides of window 18, which is defined by enclosure member 12 as illustrated in FIGS. 14 and 15.

At 316, enclosure member 12 is folded or otherwise manipulated to substantially enclose actuating member 80, movable member 14 and slotted member 130. For example, enclosure member 12 is folded about each of fold lines 58, 60 and 62 and flaps 54 and 56 are coupled with rear panel 46 of enclosure member 12 to close enclosure member 12. In one embodiment, support substrate 74 is coupled to a portion of external surface 40 of enclosure member 12 defined by rear panel 46 to provide additional rigidity and strength to transaction product 10. Support substrate 74 may be coupled to rear panel 46 at any suitable time during method 300.

At 318, account identifier 16 is added to transaction product 10, if account identifier is not already part of transaction product 10. Although pictured in FIG. 18 as occurring after all of operations 310, 312, 314 and 316, it should be understood that account identifier 20 may be applied to any suitable portion of transaction product 10 at any suitable time during manufacturing and assembly thereof. For example, account identifier 16 may be printed to enclosure member 12 while enclosure 12 is unfolded, may be enclosed within enclosure member 12 when enclosure member 12 is closed and/or may be printed or otherwise applied to support substrate 74 before or after coupling support substrate 74 to enclosure member 12 as will be apparent to those of skill in the art upon reading this application

At 320, transaction product 10 is coupled with backer 250 as generally illustrated with additional reference to FIGS. 16 and 17 to form transaction product assembly 256. Transaction product 10 may be adhered, skinned to, blister packed with or otherwise suitably coupled with backer 250. In one embodiment, account identifier 16 of transaction product 10 is accessible for scanning while transaction product 10 is coupled with backer 250, for example, through opening 270 in backer 250.

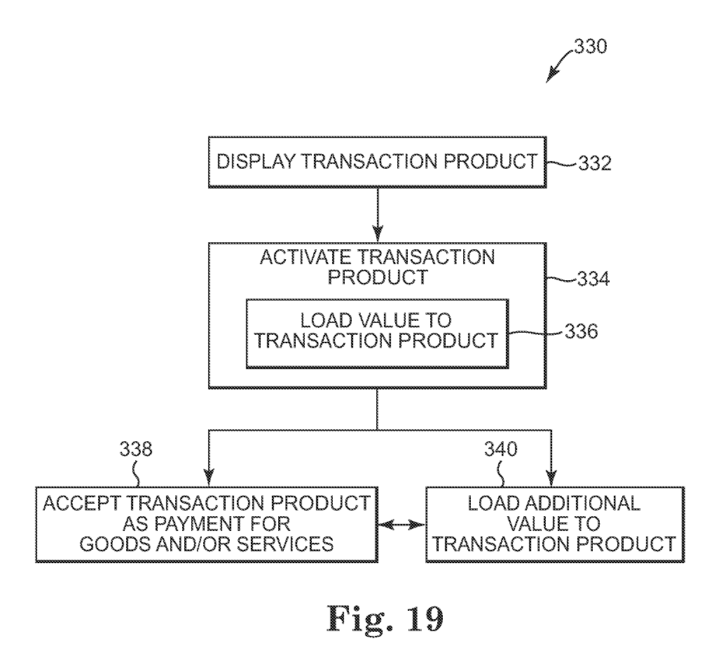

FIG. 19 is a flow chart illustrating one embodiment of a method 330 of encouraging purchase and facilitating use of transaction product 10 by consumers and/or recipients. At 332, transaction product 10 is placed on or hung from a rack, shelf or other similar device to display transaction product 10 for sale to potential consumers. In one embodiment, a depiction of transaction product 10 is placed on a web site for viewing and purchase by potential consumers.

At 334, a consumer who has decided to purchase transaction product 10 presents transaction product 10 with or without backer 250 to a retail store employee, retail store kiosk, remote terminal or other person or device to scan account identifier 16 to access an account or record linked to account identifier 16. In particular, account identifier 16 is scanned or otherwise accessed, for example through opening 270 of backer 250 to activate transaction product 10. Upon accessing the account or record, then, at 336, value is added to the account or record in the form of monetary value, points, minutes, etc. Thus, transaction product 10 is activated and loaded.

In one example, a predetermined value is associated with transaction product 10 (i.e., associated with the account or record linked to transaction product 10 via account identifier 16) prior to activation and display, but such predetermined value is not initially available for use toward the purchase or use of goods and/or services. In such an embodiment, at 334, transaction product 10 is activated to permit subsequent access to the predetermined value (e.g., subsequent loading on and debiting from the account or record) and no additional value is added during activation such that operation 336 may be eliminated.

Once transaction product 10 is activated and loaded, transaction product 10 can be used by the consumer or any other bearer of transaction product 10 to purchase goods and/or services at the affiliated retail setting (e.g., a retail store or web site) or can be used in exchange for calling minutes, etc. In one embodiment, where transaction product 10 is displayed on a web site at 332, then, at 334, transaction product 10 may be activated in any suitable method and may not require the physical scanning of account identifier 16 to be activated or to otherwise access the associated account or record such as at 336.

In one example, at 338, the retail store or other affiliated retail setting or web site accepts transaction product 10 as payment toward the purchase of goods and/or services made by the current bearer of transaction product 10. In particular, the value currently loaded on transaction product 10 (i.e., stored or recorded in the account or record linked to account identifier 16) is applied toward the purchase of goods and/or services. At 340, additional value is optionally loaded on transaction product 10 at a point-of-sale terminal, kiosk or other area of the retail store, retail web site, or other related setting.

Upon accepting transaction product 10 as payment at 338, the retail store or related setting can subsequently perform either operation 338 again or operation 340 as requested by a current bearer of transaction product 10. Similarly, upon loading additional value on transaction product 10 at 340, the retail store or related setting can subsequently perform either operation 340 again or operation 338. In one example, the ability to accept transaction product 10 as payment for goods and/or services is limited by whether the account or record associated with transaction product 10 has any value stored or recorded therein at the time of attempted redemption.

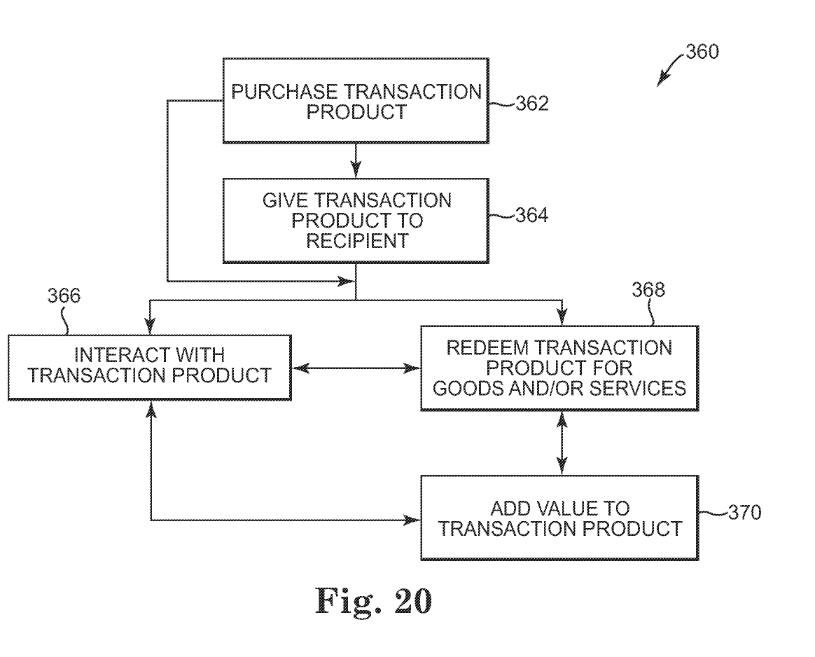

FIG. 20 is a flow chart illustrating one embodiment of a method 360 of using transaction product 10 (e.g., FIGS. 1-6). At 362, a potential consumer of transaction product 10, which is displayed in a retail store or viewed on a web site, decides to and does purchase transaction product 10 from the retail store or web site. It should be understood that transaction product 10 can be displayed and purchased alone or as part of transaction product assembly 256 (FIG. 17) along with backer 250.

Upon purchasing transaction product 10, a retail store employee, a retail store kiosk or other person or device scans account identifier 16 (FIG. 3), for example, through opening 270 of backer 250 or otherwise reads or accesses account identifier 16. Upon accessing account identifier 16, the account or record linked to account identifier 16 is accessed and activated to load value onto transaction product 10 (i.e., load value to the account or record associated with transaction product 10). In one embodiment, such as where transaction product 10 is purchased at 362 via a web site, actual scanning or other mechanical detection of account identifier 16 may be eliminated and/or manual input of code 30 may be added.

At 364, the consumer optionally gives transaction product 10 to a recipient, such as a graduate, relative, friend, expectant parents, one having a recent or impending birthday, a couple having a recent or impending anniversary, etc. In one embodiment, a plurality of transaction products 10 are purchased and given to party goers, such as at a birthday party, etc. as party favors or gifts. As an alternative, the consumer can keep transaction product 10 for his or her own use thereby eliminating operation 364.

At 366, the consumer, recipient or other current bearer of transaction product 10 interacts with transaction product 10. In one embodiment, playing or otherwise interacting with transaction product 10 at 366 includes transitioning movable member 14 between a first position and a second position wherein a different portion of movable member 14 is viewable through window 18 of enclosure member 12 when movable member 14 is in the first position than when movable member 14 is in the second position. In one embodiment, playing or otherwise interacting with transaction product 10 at 366 more specifically includes pulling or otherwise applying force to actuating member 80 as generally indicated by arrow 142 in FIGS. 7 and 15 to move actuating member 80 from the compact position (FIGS. 2 and 14) through the intermediate position (FIG. 7) and to the extended position (FIGS. 8 and 15). In one example, provided the coupling of movable member 14 to actuating member 80 and enclosure member 12 as described above, movement of actuating member 80 from the compact position through the intermediate position and to the extended position automatically causes reciprocal movement of movable member 14 from the first position (FIGS. 2 and 14), through an intermediate position (FIG. 7) and to the second position (FIGS. 8 and 15). Other methods of actuating movement or scrolling of movable member 14 will be apparent to those of skill in the art upon reading this application. In one example, interaction with transaction product 10 at 366 amuses the bearer and any other observers of transaction product 10.

At 368, the consumer or recipient redeems transaction product 10 for goods and/or services from the retail store or web site. At 370, the consumer or recipient of transaction product 10 optionally adds value to transaction product 10, more particularly, to the account or record associated with account identifier 16 included therewith, at the retail store or over the Internet (i.e., via the web site). Upon playing with transaction product 10 at 366, redeeming transaction product 10 at 368 or adding value to transaction product 10 at 370, the consumer or recipient of transaction product 10 subsequently can perform either of operations 366, 368 or 370 as desired. In one embodiment, the ability of the consumer or recipient to repeat redeeming transaction product 10 at 370 is limited by whether the account or record linked with transaction product 10 has any remaining value stored or recorded therein at the time of attempted redemption.

Although primarily described above as occurring at a single retail store or web site, in one embodiment, purchasing transaction product 10 at 362, redeeming transaction product 10 at 368 and adding value to transaction product 10 at 370, can each be performed at any one of a number of stores adapted to accept transaction product 10 or over the Internet. In one example, each of the number of stores is part of a chain or a group of similarly branded stores. In one example, the number of stores includes at least one web site and/or at least one conventional brick and mortar store.

Transaction products come in many forms, according to embodiments of the invention. The gift card, like other transaction products, can be “re-charged” or “re-loaded” at the direction of the original consumer, the gift recipient or a third party. The term “loading on” or “loaded on” herein should be interpreted to include adding to the balance of an account or record associated with a transaction product. The balance associated with the transaction product declines as the transaction product is used, encouraging repeat visits or use. The transaction product remains in the user's purse or wallet, serving as an advertisement or a reminder to revisit the associated merchant. Gift cards according to embodiments of the invention provide a number of advantages to both the consumer and the merchant. Other transaction products according to embodiments of the invention include loyalty cards, merchandise return cards, electronic gift certificates, calling cards, employee cards, frequency cards, prepaid cards and other types of cards associated with or representing purchasing power, monetary value, etc.

Although the invention has been described with respect to particular embodiments, such embodiments are for illustrative purposes only and should not be considered to limit the invention. Various alternatives and other modifications within the scope of the invention in its various embodiments will be apparent to those of ordinary skill.

What is claimed is:

1. A transaction product, comprising:
a first member defining a window;
a second member substantially enclosed within the first member, the second member depicting a first image and a second image, wherein the second member is selectively movable relative to the first member between a first position, in which the first image is viewable through the window, and a second position, in which the second image is viewable through the window; and
an account identifier linking the transaction product to an account or record, wherein the account identifier is machine readable, wherein the account identifier is at least one of connected to and substantially enclosed within the first member.

2. The transaction product of claim 1, wherein the account identifier is a bar code connected to the first member.

3. The transaction product of claim 1, wherein the account identifier includes at least one of a bar code, a magnetic strip, a smart chip and a radio frequency identification (RFID) device.

4. The transaction product of claim 1, wherein when the second member is in the first position, the second image is hidden from view by the first member, and when the second member is in the second position, the first image is hidden from view by the first member.

5. The transaction product of claim 1, wherein the second member is a substantially planar and elongated member defining a front surface and a rear surface opposite the front surface, the first image is longitudinally spaced from the second image on the second member, and each of the first image and the second image is defined on the front surface of the second member.

6. The transaction product of claim 5, further comprising a third member configured to move between a compact position, in which the third member is substantially enclosed within the first member, and an extended position, in which the third member extends out of the first member, wherein the second member is rigidly secured to the third member between the first image and the second image.

7. The transaction product of claim 1, wherein the second member includes a first end and a second end, the first end of the second member is coupled to the first member on a first side of the window, and the second end of the second member is coupled to the first member on a second side of the window opposite the first side of the window.

8. The transaction product of claim 1, wherein the second member transitions through an intermediate position when the second member moves from the first position to the second position, and wherein a portion of the first image and a portion of the second image are each viewable through the window when the second member is in the intermediate position.

9. The transaction product of claim 1, further comprising a third member coupled with the second member, wherein the third member is configured to transition between a compact position, in which the third member is substantially maintained within the first member, to an extended position, in which the third member at least partially extends out of the first member, and movement of the third member between the compact position and the extended position causes movement of the second member between the first position and the second position.

10. The transaction product of claim 9, wherein the third member includes message fields, the message fields are hidden from view by the first member when the third member is in the compact position, and the message fields are viewable when the third member is in the extended position.

11. The transaction product of claim 9, wherein the first member includes a front panel, which defines the window, and an end opening defined generally perpendicular to the front panel, wherein the third member is accessible from the end opening when the third member is in the compact position, and the third member extends from the end opening when the third member is in the extended position.

12. The transaction product of claim 1, further comprising a support substrate coupled to the first member to add strength and rigidity to the transaction product.

13. The transaction product of claim 1, wherein one of the first image and the second image includes a pictorial graphic and a different one of the first image and the second image includes a text message.

14. The transaction product of claim 1, in combination with a carrier releasably coupled to the first member.

15. A stored-value product comprising:
means for linking the stored-value product with at least one of an account and a record having a value associated therewith such that the stored-value product can be used as payment toward one of a use and a purchase of one or more of goods and services;
means for depicting a first image;
means for substantially enclosing the means for depicting the first image; and
means for actuating the stored-value product to selectively hide and reveal the first image;
wherein interaction between a bearer of the stored-value product and the means for actuating causes the means for depicting the first image to move relative to the means for substantially enclosing between a first position, in which the first image is hidden by the means for substantially enclosing, and a second position, in which the first image is revealed for viewing.

16. The stored-value product of claim 15, wherein the means for depicting the first image is rigidly coupled to the means for substantially enclosing, and the means for actuating is rigidly coupled to the means for depicting the first image.

17. The stored-value product of claim 15, wherein the means for actuating is configured to be linearly slid relative to the means for substantially enclosing to actuate the stored-value product to selectively hide and reveal the first image, and wherein the means for actuating is formed separately from the means for depicting the first image.

18. The stored-value product of claim 15, wherein the means for depicting the first image also depicts a second image, and wherein when the first image is hidden by the means for substantially enclosing, the second image is revealed, and when the first image is revealed, the second image is hidden by the means for substantially enclosing.

19. A method of encouraging purchase and facilitating use of a stored-value card linked to a record or account, the method comprising:
displaying the stored-value card to a potential consumer, the stored-value card including an external member defining a window, a movable member depicting a first image and a second image, and an account identifier linking the stored-value card to the record or account, wherein the movable member defines a first end and a second end opposite the first end, the first end is rigidly coupled to the external member on a first side of the window, the second end is rigidly coupled to the external member on a second side of the window, which is opposite the first side of the window, and wherein the second member is selectively movable relative to the window between a first position and a second position, wherein only the first image is viewable through the window in the first position, and only the second image is viewable through the window in the second position; and
activating the record or account linked to the stored-value card to permit subsequent deductions from a value associated with the record or account for application toward one of a purchase and a use of one or more of goods and services.

20. The method of claim 19, wherein the stored-value card includes an actuating member coupled with the movable member, wherein during displaying of the stored-value card, the potential consumer is able to interact with the actuating member, which causes the movable member to move between the first position and the second position.

21. A method of assembling a transaction card, the method comprising:
coupling a first member, which depicts a graphical image, to a second member;
coupling opposing ends of the first member to an enclosure member such that the enclosure member substantially encloses the first member, wherein the second member is configured to move relative to the enclosure member, and movement of the second member relative to the enclosure member causes movement of a portion of the first member between the first end and the second end, wherein the movement of the portion of the first member causes the graphical image to be selectively viewed through and hidden by the enclosure member; and
applying an account identifier to the transaction card, wherein the account identifier links the transaction card to an account or record.

22. The method of claim 21, further comprising enclosing the second member within the enclosure member, wherein the second member is configured to move relative to the enclosure member between a compact position substantially within the enclosure member and an extended position, in which the second member extends out of the enclosure member further than when the second member is in the compact position.

23. The method of claim 21, wherein the first member depicts a text image, and movement of the second member relative to the enclosure member causes movement of the portion of the first member between a first position and a second position, wherein in the first position, only one of the graphical image and the text image is viewable through the enclosure member, and in the second position, only a different one of the graphical image and the text image is viewable through the enclosure member.
